(19) United States
(12) Patent Application Publication
(10) Pub. No.: US 2021/0279809 A1
(43) Pub. Date: Sep. 9, 2021

(54) SYSTEM AND METHOD FOR AUTOMATED ASSESSMENT OF TRANSACTION PROCESSING

(71) Applicant: Cognizant Technology Solutions U.S. Corp, Teaneck, NJ (US)

(72) Inventor: Andrew Penner, Eagle, ID (US)

(21) Appl. No.: 16/812,998

(22) Filed: Mar. 9, 2020

(51) Int. Cl. G06Q 40/08; G06N 20/00; G06Q 20/02

(52) U.S. Cl. CPC G06Q 40/08; G06Q 20/02; G06N 20/00

(57) ABSTRACT

A system and a method for automated assessment of transaction processing is disclosed. The present invention triggers automated assessment of one or more outcomes of transaction processing in response to messages generated based on a transaction claim received by a transaction processing system. The present invention categorizes the one or more outcomes of transaction processing into predetermined categories. Further, a probability of one or more parameters associated with selected category of outcome is computed. Furthermore, a probability of each of the parameters is computed using one or more machine learning models. Yet further, one or more actionable(s) are generated based on a comparison between the computed one or more probabilities and predefined thresholds. The one or more actionable(s) are executed using one or more Application programing interface (API) calls to the transaction processing system, thereby, significantly reducing human intervention.

### FIELD OF THE INVENTION

The present invention relates generally to transaction processing, and more particularly, the present invention relates to a system and a method for automated assessment of transaction processing.

### BACKGROUND OF THE INVENTION

Generally, transaction processing systems deployed by third party payer services are configured to process transactions for members of said third party payer services. Examples of third party payer services includes, but are not limited to, insurance services, credit card services, and the like. Transaction processing as referred to herein includes at least analyzing transactions; evaluation of liabilities of a service provider, member of third party payer service and third party payer service; processing of payments; requesting transaction information etc. Examples of transactions may include business transactions such as buying of goods or services, healthcare transactions such as health insurance claims etc. However, the existing transaction processing systems are deterministic in nature and require intensive human intervention in processing a transaction.

For example: a third party payer service such as a healthcare insurance company, (hereinafter referred to as an “insurer”) may pay for healthcare services received from a service provider including, but not limited to, any person, such as a doctor, pharmacist, etc., or an institution, such as a hospital, clinic, or medical equipment provider, to an insured consumer. The service provider generates a claim which includes details regarding the services rendered, drugs, healthcare supplies, medical equipment, home health, etc. to the insured consumer. Further, the claim is adjudicated by the healthcare insurance company via the transaction processing systems. The transaction processing systems evaluate the liability of one or more parties (e.g., the patient/member, insurer, service provider, etc.) for a given healthcare service based on predefined relationships such as contracts between the insurer and service provider and/or insured member's healthcare plan. In some instances, an outcome of transaction processing may be issuance of complete payment associated with the claims. In other instances, the outcome of transaction processing may be denying the claims, requesting for more information, requesting for explanations, providing claim adjustment options etc. The entire process of gathering more information, claim adjustments etc. is complex, time consuming and requires human intervention to assess the outcome of transaction processing.

In light of the above drawbacks, there is a need for a system and method which provides automated assessment of transaction processing. There is a need for a system and method which automatically makes adjustments to an outcome of transaction processing. Further, there is a need for a system and method which significantly reduces human intervention. Furthermore, there is a need for a system and a method which is inexpensive and can be easily integrated with any existing transaction processing systems.

### SUMMARY OF THE INVENTION

In various embodiments of the present invention, a method for automated assessment of transaction processing is provided. The method is implemented by at least one processor executing program instructions stored in a memory. The method comprises categorizing one or more outcomes of transaction processing extracted from one or more messages received from a transaction processing system into predetermined categories. The method further comprises computing probability of one or more predefined parameters associated with a selected category of outcome from the predetermined categories. Furthermore, the method comprises generating one or more actionable(s) based on a comparison between the computed probability of the one or more predefined parameters with corresponding predefined thresholds. Finally, the method comprises executing the one or more actionable(s) using one or more API calls to the transaction processing system.

In various embodiments of the present invention, a system for automated assessment of transaction processing interfacing with a transaction processing system is provided. The system comprises a memory storing program instructions, a processor configured to execute program instructions stored in the memory, and a transaction outcome assessment engine executed by the processor. The system configured to categorize one or more outcomes of transaction processing extracted from one or more messages received from a transaction processing system into predetermined categories. Further, the system is configured to compute probability of one or more predefined parameters associated with a selected category of outcome from the predetermined categories. Furthermore, the system is configured to generate one or more actionable(s) based on a comparison between the computed probability of the one or more predefined parameters with corresponding predefined thresholds. Yet further, the system is configured to execute the one or more actionable(s) using one or more API calls to the transaction processing system.

In various embodiments of the present invention, a computer program product is provided. The computer program product comprises a non-transitory computer-readable medium having computer-readable program code stored thereon, the computer-readable program code comprising instructions that, when executed by a processor, cause the processor to categorize one or more outcomes of transaction processing extracted from one or more messages received from a transaction processing system into predetermined categories. Further, probability of one or more predefined parameters associated with a selected category of outcome from the predetermined categories is computed. Furthermore, one or more actionable(s) are generated based on a comparison between the computed probability of the one or more predefined parameters with corresponding predefined thresholds. Yet further, the one or more actionable(s) are executed using one or more API calls to the transaction processing system.

### BRIEF DESCRIPTION OF THE ACCOMPANYING DRAWINGS

The present invention is described by way of embodiments illustrated in the accompanying drawings wherein:

FIG. 1 illustrates a block diagram of a system for automated assessment of transaction processing, in accordance with an embodiment of the present invention;

FIG. 2 is a flowchart illustrating a method for automated assessment of transaction processing, in accordance with an embodiment of the present invention; and

FIG. 3 illustrates an exemplary computer system in which various embodiments of the present invention may be implemented.

### DETAILED DESCRIPTION OF THE INVENTION

The present invention discloses a system and a method for automated assessment of transaction processing. In particular, the present invention triggers automated assessment of one or more outcomes of transaction processing in response to messages which are generated based on a transaction claim received by a transaction processing system. The present invention categorizes the one or more outcomes of transaction processing into predetermined categories. Further, a probability of one or more parameters associated with selected category of outcome is computed. The present invention further provides for computing a probability of each of the parameters by using one or more machine learning models. Further, the present invention provides for generating one or more actionable(s) based on a comparison between the computed one or more probabilities and predefined thresholds. The one or more actionable(s) are executed using one or more Application Programing Interface (API) calls to the transaction processing system, thereby, significantly reducing human intervention.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention. The term transaction processing as used in the specification refers to at least analyzing transactions; evaluating liabilities of a service provider, member of third party payer service and third party payer service; processing of payments; requesting transaction information etc. The term “actionable(s)” as used in the specification refers to the list of steps which may be executed to achieve desired objective.

The present invention would now be discussed in context of embodiments as illustrated in the accompanying drawings.

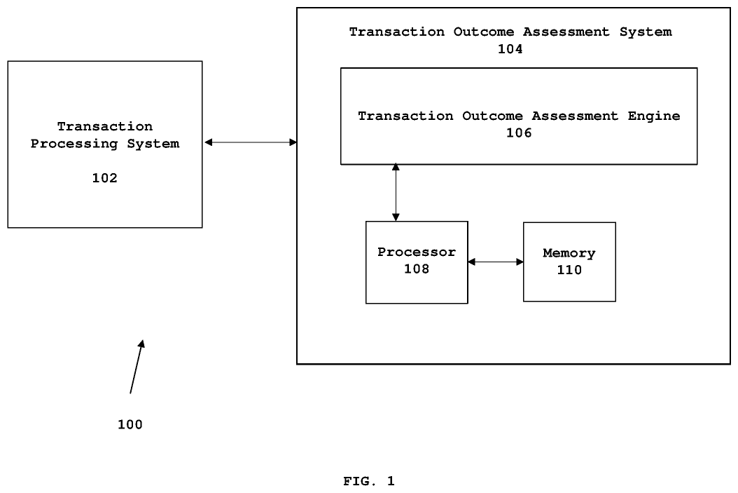

FIG. 1 illustrates a block diagram of a system for automated assessment of transaction processing, in accordance with an embodiment of the present invention. Referring to FIG. 1, in an embodiment of the present invention, a deployment environment 100 is illustrated which comprises a transaction processing system 102 and a system for automated assessment of transaction processing (hereinafter referred to as transaction outcome assessment system 104).

In various embodiments of the present invention, the transaction processing system 102 may be deployed by a third-party payer service such as an insurance service, credit card service and the like. The transaction processing system 102 may be a hardware, a software or a combination of hardware and software which is configured to collect data, process data, process transactions, evaluate transactions etc. In an exemplary embodiment of the present invention, the transactions may include, but are not limited to, claims, enrollment, utilization management, capitation, etc. In an exemplary embodiment of the present invention, the transaction processing system 102 is TriZetto Facets® which may be deployed in a computing device of the third-party payer. In an embodiment of the present invention, the transaction processing system 102 is configured to receive transaction claims from one or more service providers. The transaction claim is representative of information associated with services rendered by a service provider to a member of the third-party payer service (herein after referred to as third-party member). The transaction processing system 102 processes the transaction claim. The processing of transaction claim includes, but is not limited to, analyzing and storing the transaction claim, evaluating liabilities of the service provider, the third-party member and the third-party payer service using predefined rules and generating one or more outcomes. The transaction processing system 102 subsequently generates one or more messages associated with transaction processing. Each of the one or more messages represent information associated with the transaction processing such as transaction claim, liabilities of associated parties, one or more outcomes etc. In an exemplary embodiment of the present invention, where the transaction processing system 102 is TriZetto Facets®^{,} the generated one or more messages are IOT (internet of things) messages are generated.

In an exemplary embodiment of the present invention, the transaction processing system 102 may be deployed by a healthcare insurance company, (hereinafter referred to as an “insurer”). The insurer may pay for healthcare services received from a service provider including, but not limited to, any person, such as a doctor, pharmacist, etc., or an institution, such as a hospital, clinic, or medical equipment provider, to an insured member. The service provider generates a transaction claim which includes details (such as amount, member, date etc.) pertaining to the services rendered such as drugs, healthcare supplies, medical equipment, home health, etc. to the insured member. Further, the transaction processing system 102 receives the transaction claim and analyses said claim for evaluating liability of one or more parties (e.g., the patient/member, insurer, service provider, etc.) for a given healthcare service. In an embodiment of the present invention, the evaluation may be performed based on predefined relationships such as contracts between the insurer and service provider and/or insured member's healthcare plan and generates an outcome. In an exemplary embodiment of the present invention, an outcome of transaction processing may be issuance of complete payment associated with the transaction claims. In another exemplary embodiment of the present invention, the outcome of transaction processing may be denying the transaction claims, requesting for more information, requesting explanations, providing claim adjustment options etc.

In various embodiments of the present invention, the transaction outcome assessment system 104 may be hardware, a software or a combination of hardware and software. In an embodiment of the present invention, as shown in FIG. 1, the transaction outcome assessment system 104 interfaces with the transaction processing system 102 over a communication channel (not shown). The communication channel (not shown)may include a physical transmission medium, such as, a wire, or a logical connection over a multiplexed medium, such as, a radio channel in telecommunications and computer networking. The examples of radio channel in telecommunications and computer networking may include, but are not limited to a Local Area Network (LAN), a Metropolitan Area Network (MAN), and a Wide Area Network (WAN). In another embodiment of the present invention, the transaction outcome assessment system 104 may be an integral unit of the transaction processing system, and may be deployed in a computing device of the third party payer service.

In an embodiment of the present invention, the transaction outcome assessment system 104 may be implemented in a cloud computing architecture in which data, applications, services, and other resources are stored and delivered through shared data-centers. In an exemplary embodiment of the present invention, the functionalities of the transaction outcome assessment system 104 may be delivered to the transaction processing system 102 as software as a service (SAAS). In an exemplary embodiment of the present invention, the transaction outcome assessment system 104 may be implemented in Microsoft Azure cloud. In another embodiment of the present invention, the transaction outcome assessment system 104 may be implemented as a client-server architecture, where the transaction processing system accesses a server hosting the transaction outcome assessment system 104 over a communication channel.

In an embodiment of the present invention as shown in FIG. 1, the transaction outcome assessment system 104 comprises a transaction outcome assessment engine 106, a processor 108 and a memory 110. The transaction outcome assessment engine 106 is configured to analyze information associated with transaction claims, compute probabilities of one or more outcomes of transaction processing, provide actionable(s) and execute actionable(s). In particular, the transaction outcome assessment engine 106 is configured to receive one or more messages associated with the transaction claim generated by the transaction processing system 102. The received one or more messages triggers the transaction outcome assessment engine 106 to initiate assessing of outcomes of the transaction processing.

In operation, the transaction outcome assessment engine 106 extracts the information associated with transaction processing from the one or more messages. Further the transaction outcome assessment engine 106 categorizes the one or more outcomes of transaction processing into predetermined categories using machine learning models on the extracted information. In an exemplary embodiment of the present invention, where the transaction claim is associated with health care insurance, the one or more outcomes may include, but are not limited to, claim adjustments, partial payments, requesting explanations etc. In an exemplary embodiment of the present invention, the machine learning models are built based on historical data using one or more machine learning techniques. The historical data may include, but is not limited to, previous transaction claims.

In an embodiment of the present invention, the transaction outcome assessment engine 106 is configured to select one of the one or more categories of the outcomes. The transaction outcome assessment engine 106 further selects one or more machine learning models based on a selected category of outcome. In an embodiment of the present invention, the one or more machine learning models may be trained using historical data. In an exemplary embodiment of the present invention, the one or more machine learning models may be selected by a user via a user interface (not shown) associated with the transaction outcome assessment engine 106. The transaction outcome assessment engine 106 computes a probability of one or more predefined parameters associated with the selected category of outcome. In an exemplary embodiment of the present invention with reference to paragraph 21, where the selected category of outcome is claim adjustment, the one or more parameters may include leaving of a health plan by the member, appealing against claim by the member or the service provider, successful claim adjustment etc.

The transaction outcome assessment engine 106, computes a probability of each of the one or more parameters associated with selected category of outcome using the selected machine learning models. In an exemplary embodiment of the present invention with reference to paragraph 22, where the one or more parameters include leaving of a health plan by the member, appealing against claim by the member or the service provider, successful claim adjustment etc., the transaction outcome assessment engine 106 computes a probability of each of the parameters.

The transaction outcome assessment engine 106 compares the computed probabilities with respective predefined thresholds. In an exemplary embodiment of the present invention, said thresholds are predefined by the end user. Further, the transaction outcome assessment engine 106 is configured to generate one or more actionable(s) based on the comparison between the computed probabilities with respective predefined thresholds. The term “actionables” as used in the specification refers to the list of steps which may be executed to achieve desired objective. In an exemplary embodiment of the present invention, one or more actionable(s) are generated if the probability of the computed parameters is greater than or less than respective threshold limits.

In the exemplary embodiment of the present invention, where the one or more parameters include leaving of a health plan by the member, appealing against claim by the member or the service provider, successful claim adjustment etc., the transaction outcome assessment engine 106 prioritizes the parameters in accordance with a predefined order. In an exemplary embodiment of the present invention, the order of priority may be member leaving the health plan, successful claim adjustment and appealing against claim by the member or the service provider. The transaction outcome assessment engine 106 may generate an actionable if the probability of a member leaving the health plan exceeds corresponding threshold limit and the probability of successful claim adjustment is below the corresponding threshold limit.

The transaction outcome assessment engine 106, further executes the one or more actionable(s) using one or more Application Programming Interface (API) calls to the transaction processing system 102.

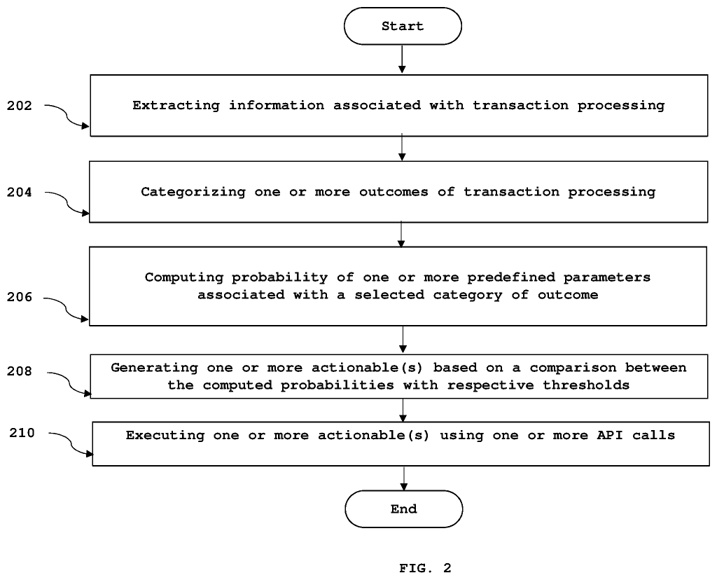

FIG. 2 is a flowchart illustrating a method for automated assessment of transaction processing, in accordance with an embodiment of the present invention.

At step 202, information associated with transaction processing is extracted. In an embodiment of the present invention, information associated with transaction processing is extracted from one or more messages associated with a transaction claim. In an embodiment of the present invention, the one or more messages are generated by a transaction processing system 102 of FIG. 1 on receiving a transaction claim. The transaction claim is representative of information associated with services rendered by a service provider to a member of the third-party payer service (hereinafter referred to as third-party member). The transaction processing system of FIG. 1 analyses the transaction claim, evaluates the liabilities of one or more parties to the transaction, and accordingly generates one or more outcomes. In an exemplary embodiment of the present invention, an outcome of transaction processing may be issuance of complete payment associated with the transaction claims. In another exemplary embodiment of the present invention, the outcome of transaction processing may be denying the transaction claims, requesting for more information, requesting explanations, providing claim adjustment options etc. Each of the one or more messages represent information associated with the transaction processing including at least the transaction claim, liabilities of associated parties and one or more outcomes. In an exemplary embodiment of the present invention, the generated one or more messages are IOT (internet of things) messages.

At step 204, one or more outcomes of transaction processing are categorized. In an embodiment of the present invention, the one or more outcomes of transaction processing are categorized into predetermined categories using machine learning models on the extracted information. In an exemplary embodiment of the present invention, where the transaction claim is associated with health care insurance, the one or more outcomes may include, but are not limited to, claim adjustments, partial payments, requesting explanations etc. and therefore the one or more predetermined categories may include, claim adjustments, partial payments, requesting explanations etc. In an exemplary embodiment of the present invention, the machine learning models are built based on historical data using one or more machine learning techniques. The historical data may include, but is not limited to, previous transaction claims maintained throughout a predefined duration.

At step 206, probability of one or more predefined parameters associated with a selected category of outcome is computed. In an embodiment of the present invention, one of the one or more categories of the outcomes is selected. Further, one or more machine learning models are selected based on the selected category of outcome. In an embodiment of the present invention, the one or more machine learning models may be trained using historical data of various transaction claims/transaction claims. A probability of each of the one or more predefined parameters associated with the selected category of outcome is computed. In an exemplary embodiment of the present invention with reference to paragraph 28, where the selected category of outcome is claim adjustment, the one or more parameters may include leaving of a health plan by the member, appealing against claim by the member or the service provider, successful claim adjustment etc. A probability of each of the parameters associated with selected category of outcome is computed using the selected machine learning tools. In an exemplary embodiment of the present invention, where the one or more parameters include leaving of a health plan by the member, appealing against claim by the member or the service provider, successful claim adjustment etc., a probability of each of the parameters is computed.

At step 208, one or more actionable(s) are generated based on a comparison between the computed probabilities with respective thresholds. In an embodiment of the present invention, the computed probabilities are compared with respective predefined thresholds. The one or more actionable(s) are generated if the probability of the computed parameters is greater than or less than respective threshold limits. In the exemplary embodiment of the present invention, where the one or more parameters include leaving of a health plan by the member, appealing against claim by the member or the service provider, successful claim adjustment etc., the one or more parameters are prioritized in accordance with a predefined order. In an exemplary embodiment of the present invention, the order of priority may be member leaving the health plan, successful claim adjustment and appealing against claim by the member or the service provider. An actionable may be generated if the probability of a member leaving the health plan exceeds corresponding threshold limit and the probability of successful claim adjustment is below the corresponding threshold limit.

At step 210, one or more actionable(s) are executed using one or more Application Programming Interface(API) calls to the transaction processing system 102 of FIG. 1.

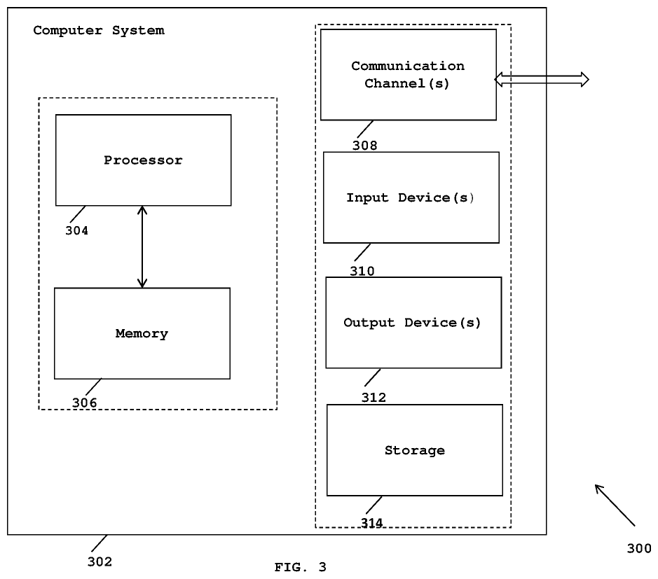

FIG. 3 illustrates an exemplary computer system in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the interne or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A method for automated assessment of transaction processing, wherein the method is implemented by at least one processor executing program instructions stored in a memory, the method comprising:
categorizing, by the processor, one or more outcomes of transaction processing extracted from one or more messages received from a transaction processing system into predetermined categories;
computing, by the processor, probability of one or more predefined parameters associated with a selected category of outcome from the predetermined categories; and
generating, by the processor, one or more actionable(s) based on a comparison between the computed probability of the one or more predefined parameters with corresponding predefined thresholds.

2. The method as claimed in claim 1, wherein the one or more actionable(s) are executed using one or more API calls to the transaction processing system.

3. The method as claimed in claim 1, wherein each of the one or more messages are generated by the transaction processing system on receiving a transaction claim, each of the one or more messages represent information associated with the transaction processing, and comprises at least a transaction claim, liabilities of associated parties and one or more outcomes.

4. The method as claimed in claim 1, wherein the one or more messages are IOT (Internet of Things) messages.

5. The method as claimed in claim 3, wherein the transaction claim includes information associated with services rendered by a service provider to a member of a third-party payer service.

6. The method as claimed in claim 1, wherein the one or more outcomes of transaction processing include issuance of complete payment associated with the transaction claims, denying transaction claims, requesting for more information, requesting explanations, and providing claim adjustment options.

7. The method as claimed in claim 3, wherein the transaction claim is associated with health care insurance, the one or more outcomes include any of: claim adjustments, partial payments, requesting explanations.

8. The method as claimed in claim 7, wherein the one or more predetermined categories include claim adjustments, partial payments, and requesting explanations.

9. The method as claimed in claim 1, wherein the one or more outcomes of transaction processing are categorized using machine leaning techniques based on historical data, wherein the historical data includes previous transaction claims maintained throughout a predefined duration.

10. The method as claimed in claim 1, wherein the probability of each of the predefined parameters associated with the selected category of outcome is computed using one or more machine learning models, wherein the one or more machine learning models are selected based on the selected category of outcome.

11. The method as claimed in claim 8, wherein the selected category of outcome is claim adjustment, the one or more predefined parameters include at least one of: leaving of a health plan by the member, appealing against claim by the member or the service provider, and successful claim adjustment.

12. The method as claimed in claim 1, wherein the one or more actionable(s) are generated if the computed probability of the predefined parameters is greater than or less than the corresponding predefined thresholds.

13. A system for automated assessment of transaction processing interfacing with a transaction processing system, the system comprising:
a memory storing program instructions; a processor configured to execute program instructions stored in the memory; and a transaction outcome assessment engine in communication with the processor and configured to:
categorize one or more outcomes of transaction processing extracted from one or more messages received from a transaction processing system into predetermined categories;
compute probability of one or more predefined parameters associated with a selected category of outcome from the predetermined categories;
generate one or more actionable(s) based on a comparison between the computed probability of the one or more predefined parameters with corresponding predefined thresholds; and
execute the one or more actionable(s) using one or more API calls to the transaction processing system.

14. The system as claimed in claim 13, wherein each of the one or more messages are generated by the transaction processing system on receiving a transaction claim, each of the one or more messages represent information associated with the transaction processing, and comprises at least a transaction claim, liabilities of associated parties and one or more outcomes.

15. The system as claimed in claim 13, wherein the one or more messages are IOT (Internet of Things) messages.

16. The system as claimed in claim 14, wherein the transaction claim includes information associated with services rendered by a service provider to a member of a third-party payer service.

17. The system as claimed in claim 13, wherein the one or more outcomes of transaction processing include issuance of complete payment associated with the transaction claims, denying transaction claims, requesting for more information, requesting explanations, and providing claim adjustment options.

18. The system as claimed in claim 14, wherein the transaction claim is associated with health care insurance, the one or more outcomes include any of: claim adjustments, partial payments, requesting explanations.

19. The system as claimed in claim 18, wherein the one or more predetermined categories are any of: claim adjustments, partial payments, and requesting explanations.

20. The system as claimed in claim 13, wherein the first set of rules comprises using machine learning techniques based on historical data, wherein the historical data includes previous transaction claims maintained throughout a predefined duration.

21. The system as claimed in claim 13, wherein the probability of each of the predefined parameters associated with the selected category of outcome is computed using one or more machine learning models, wherein the one or more machine learning models are selected based on the selected category of outcome.

22. The system as claimed in claim 19, wherein the selected category of outcome is claim adjustment, the one or more predefined parameters include at least one of: leaving of a health plan by the member, appealing against claim by the member or the service provider, and successful claim adjustment.

23. The system as claimed in claim 13, wherein the one or more actionable(s) are generated if the computed probability of the predefined parameters is greater than or less than the corresponding predefined thresholds.

24. A computer program product comprising:
a non-transitory computer-readable medium having computer-readable program code stored thereon, the computer-readable program code comprising instructions that, when executed by a processor, cause the processor to:
categorize one or more outcomes of transaction processing extracted from one or more messages received from a transaction processing system into predetermined categories;
compute probability of one or more predefined parameters associated with a selected category of outcome from the predetermined categories;
generate one or more actionable(s) based on a comparison between the computed probability of the one or more predefined parameters with corresponding predefined thresholds; and
execute the one or more actionable(s) using one or more API calls to the transaction processing system.
